(19) United States
(12) Patent Application Publication
(10) Pub. No.: US 2026/0023981 A1
(43) Pub. Date: Jan. 22, 2026

(54) ACCELERATE DEEP LEARNING WITH INTER-ITERATION SCHEDULING

(71) Applicant: Intel Corporation, Santa Clara, CA (US)

(72) Inventors: Liangang Zhang, Shanghai (CN); Guokai Ma, Shanghai (CN); Jiong Gong, Shanghai (CN); Fan Zhao, Shanghai (CN)

(73) Assignee: Intel Corporation, Santa Clara, CA (US)

(21) Appl. No.: 18/995,640

(22) PCT Filed: Sep. 30, 2022
(86) PCT No.: PCT/CN2022/123615

§ 371 Date: Jan. 16, 2025

(51) Int. Cl. G06N 3/098

(52) U.S. Cl. CPC G06N 3/098

(57) ABSTRACT

Disclosed is a technical solution to accelerate deep learning with inter-iteration scheduling based on operation categorization associated with the deep learning. An example apparatus includes interface circuitry, programmable circuitry; and instructions to cause the programmable circuitry to: classify a group of operations of a distributed deep learning workload based on a resource utilization of the group of operations; select at least two operations of the group of operations for overlapped execution based on the classification and a dependency analysis of the at least two operations of the group of operations; and perform a distributed training of the distributed deep learning workload based on an execution schedule that includes overlapped execution of the selected at least two operations.

### FIELD OF THE DISCLOSURE

This disclosure relates generally to machine learning and, more particularly, to methods and apparatus to accelerate deep learning with inter-iteration scheduling based on operation categorization associated with the deep learning.

### BACKGROUND

Machine learning is a subfield of artificial intelligence. In machine learning, instead of providing explicit instructions, programmers supply data to a model. The model generates predictions and, in some examples, is trained to improve prediction accuracy. Programmers can also adjust model parameters to further improve prediction accuracy. Deep neural network (DNN) models are a type of machine learning model based on artificial neural networks. DNNs can be trained across multiple compute units in a distributed training. In distributed training, a workload is split among multiple compute units: CPUs, GPUs, TPUs, etc.

### BRIEF DESCRIPTION OF THE DRAWINGS

FIG. 1 is an example illustration of a system to accelerate deep learning.

FIG. 2 is a block diagram of example deep learning accelerator circuitry.

FIG. 3 is an example execution schedule for training of a deep learning workload.

FIG. 4 is the example execution schedule of FIG. 3 after operation classification.

FIG. 5 is the example execution schedule of FIG. 4 after identification of segments of the execution schedule for overlapped execution.

FIG. 6 is a flowchart representative of example machine readable instructions and/or example operations that may be executed by example processor circuitry to implement the deep learning accelerator circuitry of FIG. 2.

FIG. 7 is a flowchart representative of example machine readable instructions and/or example operations that may be executed by example processor circuitry to classify operations of a distributed deep learning workload.

FIG. 8 is a flowchart representative of example machine readable instructions and/or example operations that may be executed by example processor circuitry to identify overlapping operations in the distributed deep learning workload.

FIG. 9 is a flowchart representative of example machine readable instructions and/or example operations that may be executed by example processor circuitry to enable inter/intra iteration overlapping.

FIG. 10 is a flowchart representative of example machine readable instructions and/or example operations that may be executed by example processor circuitry to perform staleness aware optimization of a distributed deep learning workload.

FIG. 11 is a block diagram of an example processing platform including processor circuitry structured to execute the example machine readable instructions and/or the example operations of FIGS. 6-10 to implement the deep learning accelerator circuitry of FIG. 2.

FIG. 12 is a block diagram of an example implementation of the processor circuitry of FIG. 11.

FIG. 13 is a block diagram of another example implementation of the processor circuitry of FIG. 11.

FIG. 14 is a block diagram of an example software distribution platform (e.g., one or more servers) to distribute software (e.g., software corresponding to the example machine readable instructions of FIGS. 6-10) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of a semiconductor device, “above” is not with reference to Earth, but instead is with reference to a bulk region of a base semiconductor substrate (e.g., a semiconductor wafer) on which components of an integrated circuit are formed. Specifically, as used herein, a first component of an integrated circuit is “above” a second component when the first component is farther away from the bulk region of the semiconductor substrate than the second component.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

In general, implementing a ML/AJ system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AJ model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AJ model (e.g., without the benefit of expected (e.g., labeled) outputs).

Deep learning is a ML method that is based on learning data representations, as opposed to task-specific procedures. Deep learning models attempt to define a relationship between input data and associated output data. Deep learning is computationally intensive, requiring significant processing capabilities and resources. In recent years, deep neural network (DNN) workloads have increased in scope and complexity. Therefore, it is challenging to train a large DNN model on a single chip. Similarly, existing solutions of training a large DNN model on multiple chips have disadvantages and fail to address various technical challenges associated with such training (e.g., scalability and hardware resource utilization efficiency). With DNN workloads and models demanding increased compute power, training DNNs on a single chip is becoming increasingly challenging.

DNN workloads can be understood in terms of an execution graph. An execution graph is a directed acyclic graph (DAG) in which nodes represent computations and edges between the nodes represent execution dependencies. Training a neural network is more compute intensive than inference for a given neural network, as execution graphs for training include forward propagation operations (e.g., forward pass) to compute loss and backward propagation operations (e.g., back pass) for computing gradients. Operations of a computation graph can be executed based on a topological ordering, but such an execution schedule may not take advantage of parallel execution opportunities.

Multi-chip DNN training can alleviate the issues faced by single-chip architectures, but distribution of DNN training introduces additional computational overhead. It can also be difficult to schedule training operations in a way that provides high hardware utilization efficiency.

Examples disclosed herein schedule distributed deep learning operations according to their compute characteristics. In some examples, operations are divided into one of four categories: computation-bound, memory-bound, I/O-bound, and network-bound. Next, an inter-iteration overlapped execution can be carried out based on an inter-iteration dependency analysis. Finally, a staleness aware distributed optimizer generates an execution schedule based on the inter-iteration overlapped execution and identified communication operations. As described herein, overlapped execution may refer to complete overlap and/or a partial overlap of a plurality of (e.g., two or more) operations.

Some examples disclosed herein provide inter-iteration overlapped operation scheduling and improve distributed hardware resource utilization by assigning priorities to different operation types. Some examples disclosed herein improve DNN execution in heterogeneous compute environments. For example, a graphics processing units (GPU) may execute a computation-bound operation while a data streaming accelerator may execute a memory-bound operation.

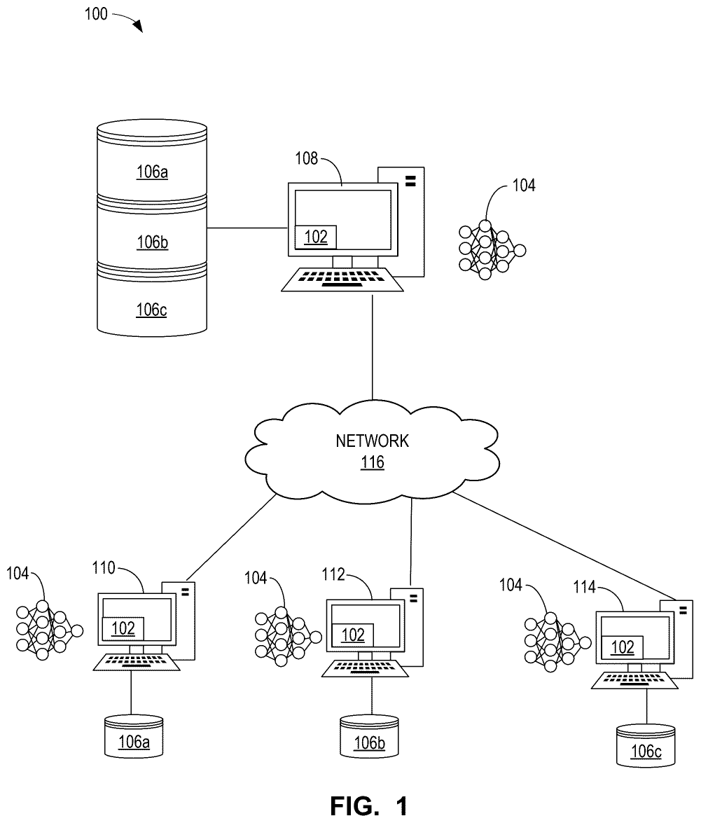

Turning to the figures, FIG. 1 is an illustration of an example distributed computing system 100. The distributed computing system 100 includes example deep learning accelerator circuitry 102, an example neural network 104, example first training data 106a, example second training data 106b, example third training data 106c, an example first workstation 108, an example second workstation 110, an example third workstation 112, an example fourth workstation 114, and an example network 116.

Training the neural network 104 with the example training data 106a-106c using only with first workstation 108 is impractical (e.g., demands excessive execution time, inadequate memory available, etc.). To efficiently train the neural network 104, the training workload is distributed to the second workstation 110, the third workstation 112, and the fourth workstation 114. Accordingly, the example system 100 is such that the training workload (e.g., the training data 106a-c) is distributed among the second workstation 110, the third workstation 112, and the fourth workstation 114.

Prior to and/or during workload execution, the neural network 104 is transmitted to one or more of the second workstation 110, the third workstation 112, and the fourth workstation 114. By transmitting the neural network 104 to each of the workstations, the workstations can each partially train the neural network 104. The results of each partial training may be combined by the example first workstation 108 to produce a final trained model that integrates the training performed on each copy of the neural network 104.

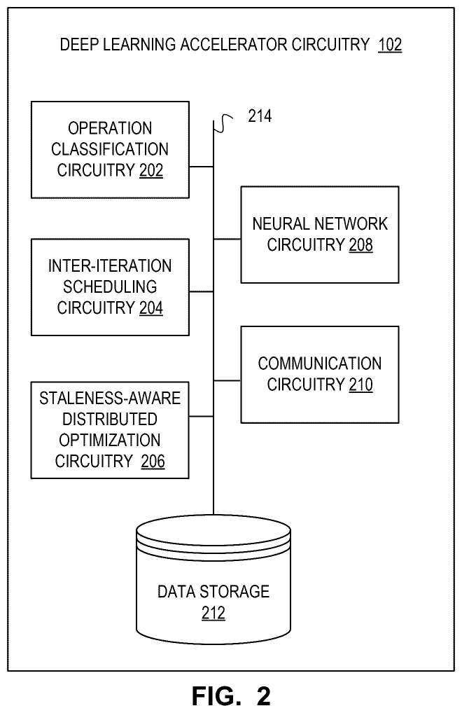

Each of the first workstation 108, the second workstation 110, the third workstation 112, and the fourth workstation 114 executes an instance of the deep learning accelerator circuitry 102. The deep learning accelerator circuitry 102 generates an execution schedule that takes into account inter-iteration overlapping operations and is resource contention aware. The structure and function of the deep learning accelerator circuitry 102 will be described in association with FIG. 2.

The first workstation 108, the second workstation 110, the third workstation 112, and the fourth workstation 114 are connected by the network 116. In some examples, the neural network 104 may be trained on a single machine with multiple processing elements that each handle a portion of the machine learning workload.

In the example of FIG. 1, a separate instance of the deep learning accelerator circuitry 102 is included in each of first workstation 108, the second workstation 110, the third workstation 112, and/or the fourth workstation 114. However, in some examples the deep learning accelerator circuitry 102 may not be included in one or more of the first workstation 108, the second workstation 110, the third workstation 112, and/or the fourth workstation 114.

FIG. 2 is a block diagram of deep learning accelerator circuitry 102 to accelerate deep learning operations. The deep learning accelerator circuitry 102 of FIG. 2 may be instantiated (e.g., creating an instance of, bring into being for any length of time, materialize, implement, etc.) by processor circuitry such as a central processing unit executing instructions. Additionally or alternatively, the deep learning accelerator circuitry 102 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

The example deep learning accelerator circuitry 102 includes example operation classification circuitry 202. The operation classification circuitry 202 classifies operations that comprise a deep learning training execution schedule. Example operations classified by the operation classification circuitry 202 may include dataloader (e.g., to read training samples, customize data loading order, batch, etc.), linear layer operations, convolutional layer operations, optimizer operations (e.g., stochastic gradient descent operations), etc.

In some examples the operation classification circuitry 202 may classify operations as computation-bound, memory-bound, I/O-bound, and/or network-bound. A computation-bound operation is an operation for which the time to complete the operation is determined principally by processor circuitry. A memory-bound operation is an operation in which the time to the operation is determined principally by memory speed and/or availability. An I/O-bound operation is an operation in which the time to complete the operation is determined principally by input/output overhead. A network-bound operation is an operation in which the time to complete the operation is determined principally by communication overhead.

The operation classification circuitry 202 may classify a plurality of operations of a distributed deep learning workload as one of network-bound, computation-bound, memory-bound, or input/output-bound based on a resource utilization of ones of the two or more operations. The plurality of operations classified by the example operation classification circuitry 202 may be assigned scheduling and/or execution priorities. In some examples, input/output-bound operations are assigned a higher scheduling priority than computation-bound operations. Operations may be associated with categories based on testing and/or analysis of resource usage during execution of the operation. Such information can be saved and used for future classification of the same operation.

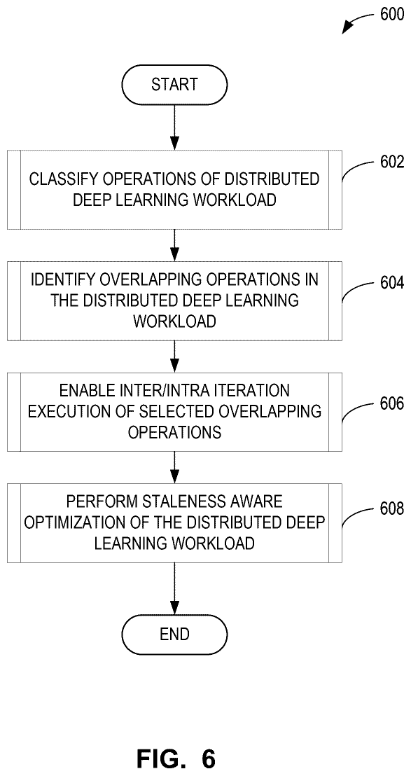

Operations of various classifications may also be transmitted to and/or executed on different compute units. For example, a computation-bound instruction may be executed on a graphics processing unit, while a memory-bound instruction may be executed on a data streaming accelerator unit. In some examples, the operation classification circuitry 202 is instantiated by processor circuitry executing operation classification instructions and/or configured to perform operations such as those represented by the flowchart of FIGS. 6-10.

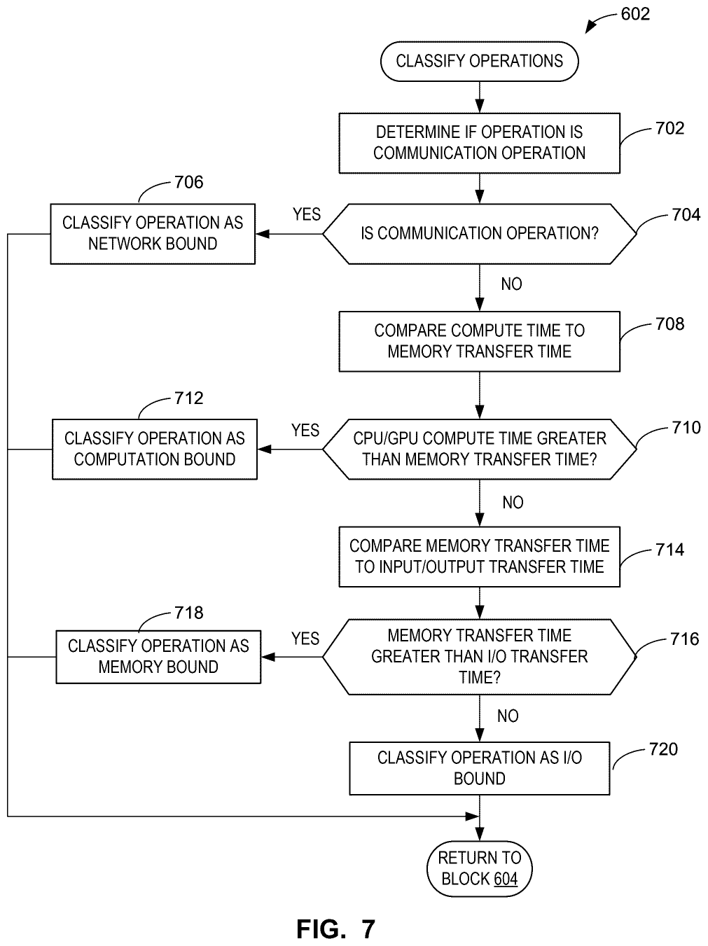

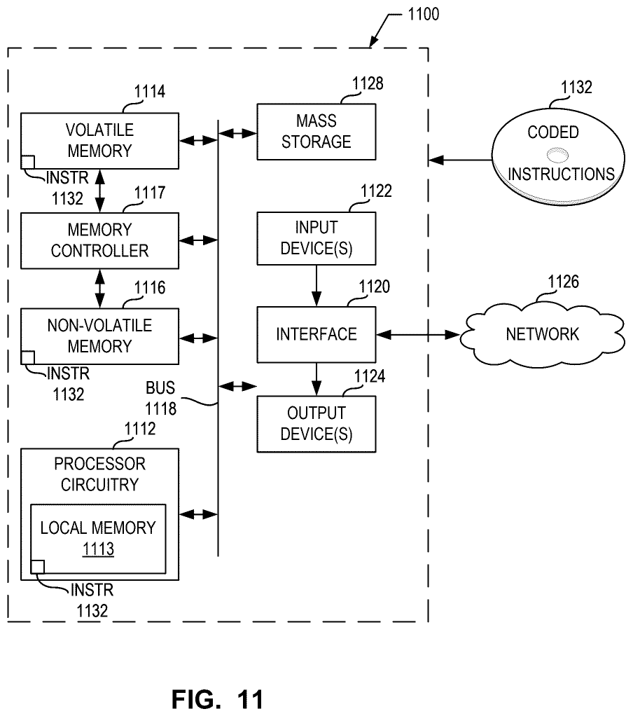

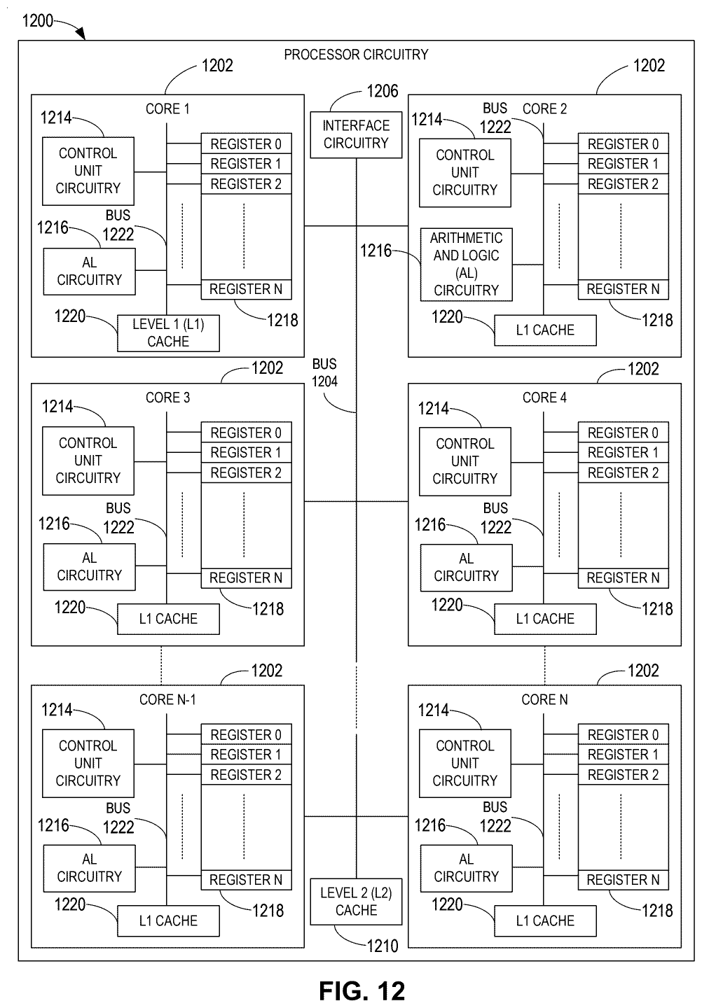

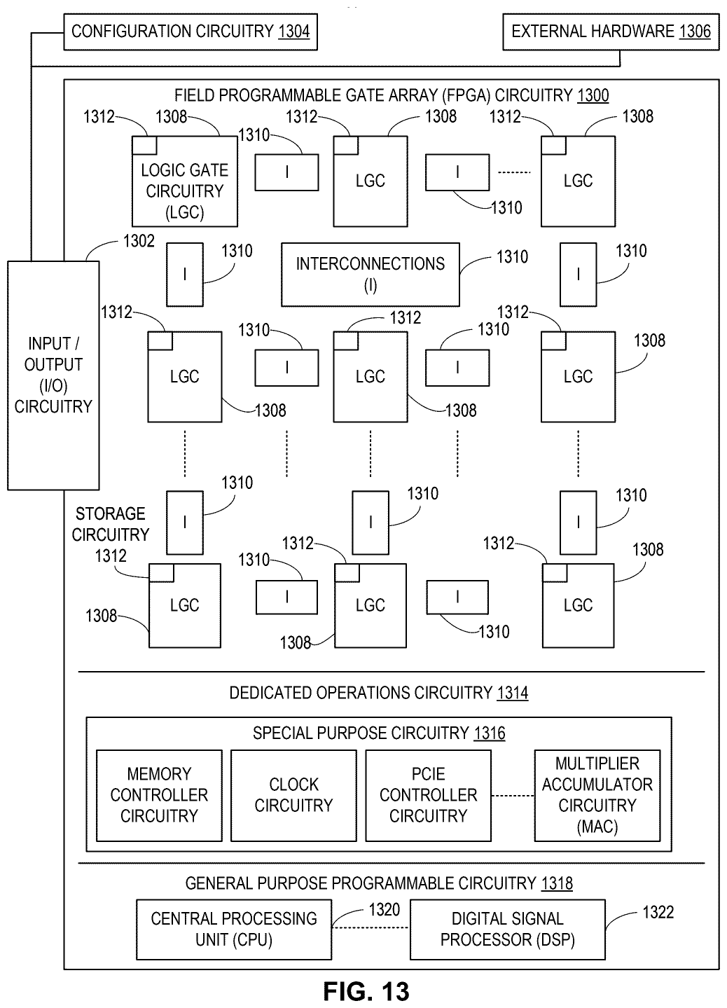

In some examples, the deep learning accelerator circuitry 102 includes means for classifying operations of a device. For example, the means for classifying may be implemented by the operation classification circuitry 202. In some examples, the operation classification circuitry 202 may be instantiated by processor circuitry such as the example processor circuitry 1112 of FIG. 11. For instance, the operation classification circuitry 202 may be instantiated by the example microprocessor 1200 of FIG. 12 executing machine executable instructions such as those implemented by at least blocks 702, 704 of FIG. 7. In some examples, operation classification circuitry 202 may be instantiated by hardware logic circuitry, which may be implemented by an ASIC, XPU, or the FPGA circuitry 1300 of FIG. 13 structured to perform operations corresponding to the machine readable instructions. Additionally or alternatively, the operation classification circuitry 202 may be instantiated by any other combination of hardware, software, and/or firmware. For example, the operation classification circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example deep learning accelerator circuitry 102 includes example inter-iteration scheduling circuitry 204. The example inter-iteration scheduling circuitry 204 generates an inter-iteration DAG. To perform inter-iteration analysis, two DAGs that each represent a single directed graph may be combined by connecting final operations of a forward propagation (e.g., a forward pass) to first operations for a subsequent back propagation (e.g., a backwards pass). Therefore, a final node and/or operation of a forward propagation may be connected to a first node and/or operation of a subsequent back propagation layer. In examples in which inference is performed, two DAGs corresponding to separate (e.g., independent) inference iterations can be connected (e.g., connected by a dummy node).

The example inter-iteration scheduling circuitry 204 may identify operations for partial overlapped execution based on their resource type and any dependencies between the operations. For example, if a first operation is limited by a first operation type (e.g., I/O-bound), a second operation is limited by a second operation type (e.g., memory-bound), and there is no data dependency between the first and second operations, then the first and second operations may be categorized for overlapped execution (e.g., at least partial overlapped execution). In some examples, network-bound communication operations are prioritized for overlapped (e.g., at least partial overlapped) execution with other types of operations. In some execution DAGs, execution paths between the parent and the child node that do not include network-bound communications can be overlapped with network-bound communications to speedup both distributed training and heterogenous computation.

The example inter-iteration scheduling circuitry 204 may perform some or all of the operations shown below in tables 1 and 2:

TABLE 1

```
Input: Inter-iteration directed graph
Output: Candidate overlapping patterns, communication op
list, op execution time
comms=[ ] #list for communication operations
for node in the graph:
  if node is not communication operation:
    break
  if node is not the last allreduce in the DDP:
    comms.append(node)
candidates={ } #dict for candidates operations
for op_c in comms:
  op_o = [node, if the output of op_c is the input of node, for
node in graph]
  candidates[op_c].append(dataloader_prefetch)
  for node in graph:
    if node in the path between op_c.parent and op_o:
      candidates[op_c].append(node)
```

Table 1 illustrates an example algorithm to identify candidate operations. In table 1, a communication operations list is generated. For each communication operation that is not the last allreduce operation in a DDP wrapper (e.g., a synchronization process across machines), each node in the operation DAG is analyzed to see if it falls between parent and child nodes of the communication operation. Thus, the method of table 1 maintains a candidate overlapping operation list for communication operations.

TABLE 2

```
Input: Inter-iteration directed graph, comms list, candidate
overlapping patterns
Output: Dictionary to map network-bound operation to the
overlapping pattern
candidates_count={ }
for comm in comms:
  for node in candidates[node]:
    candidates_count[node]++
for comm in comms:
  total_time = sum(candidates[comm].time)
  if total_time < comm.time:
    remove the comm in other candidate lists.
  else:
    while total_time > comm.time:
      operation = select operation with max count in candidates
[comm]
      if candidates_count[operation] ==1:
        break
      remove operation from candidates[comm]
      total_time = sum(candidates[comm].time)
      candidates_count[operation]
# priority I/O>computation>memory
```

Table 2 illustrates an example scheduling algorithm that may be utilized by the inter-iteration scheduling circuitry 204. The inter-iteration scheduling circuitry 204 identifies overlap in distributed training operations for communication operations. The method of Table 2 also prunes candidate lists and reorders the operations in the candidate list according to a priority (e.g., I/O-bound, computation-bound, and memory-bound). The inter-iteration scheduling circuitry 204 may also identify non-communication operations for the candidate list or for a second candidate list.

In some examples, the deep learning accelerator circuitry 102 includes means for inter/intra iteration scheduling. For example, the means for inter/intra iteration scheduling may be implemented by the example inter-iteration scheduling circuitry 204. In some examples, the example inter-iteration scheduling circuitry 204 may be instantiated by processor circuitry such as the example processor circuitry 1112 of FIG. 11. For instance, the example inter-iteration scheduling circuitry 204 may be instantiated by the example microprocessor 1200 of FIG. 12 executing machine executable instructions such as those implemented by at least blocks 602 of FIG. 6 and/or blocks 702-720 of FIG. 7. In some examples, the example inter-iteration scheduling circuitry 204 may be instantiated by hardware logic circuitry, which may be implemented by an ASIC, XPU, or the FPGA circuitry 1300 of FIG. 13 structured to perform operations corresponding to the machine readable instructions. Additionally or alternatively, the example inter-iteration scheduling circuitry 204 may be instantiated by any other combination of hardware, software, and/or firmware. For example, the example inter-iteration scheduling circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example deep learning accelerator circuitry 102 includes example staleness-aware distributed optimization circuitry 206. The staleness-aware distributed optimization circuitry 206 is a staleness-aware distributed optimizer based on synchronous stochastic gradient descent (S-SGD). S-SGD distributes training operations to multiple workers to accelerate training. However, S-SGD also introduces communication overhead for exchanging model parameters and/or gradients in each iteration.

Synchronous S-SGD uses data parallelism to train models with multiple workers (e.g., the first workstation 108, the second workstation 110, the third workstation 112, and the fourth workstation 114 of FIG. 1). Each worker is provided a copy of a deep learning model (e.g., the neural network 104 of FIG. 1) at the beginning of each iteration. Each worker takes a portion (e.g., a mini-batch) of data, with gradient updates performed in parallel by the workers. In some examples, average gradients from various workers are used to update the model.

The staleness-aware distributed optimization circuitry 206 identifies additional communication operations in some models (e.g., models with a large first layer). In models with large first layers (e.g., layers close to the input data), the staleness-aware distributed optimization circuitry 206 identifies additional communication overhead that is not overlapped with computation.

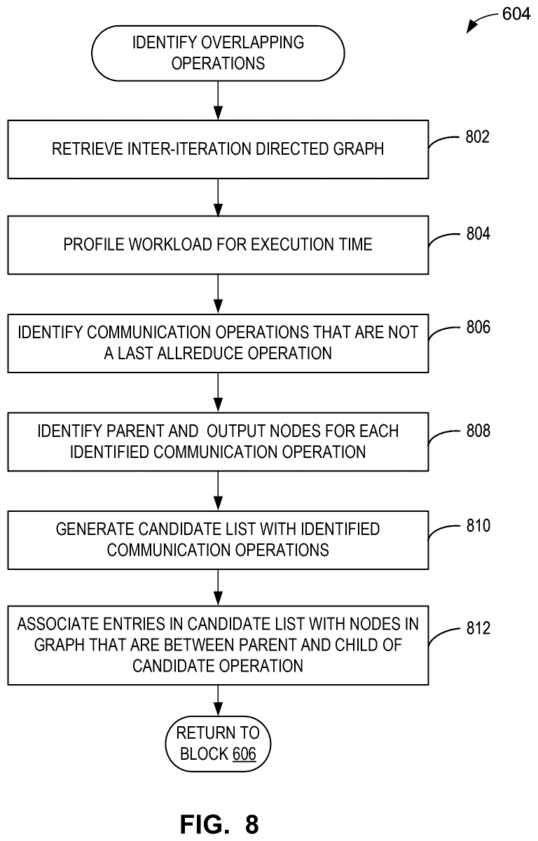

In some examples, the deep learning accelerator circuitry 102 includes means for performing a staleness-aware distributed optimization. For example, the means for performing a staleness-aware distributed optimization may be implemented by the staleness-aware distributed optimization circuitry 206. In some examples, the staleness-aware distributed optimization circuitry 206 may be instantiated by processor circuitry such as the example processor circuitry 1112 of FIG. 11. For instance, the staleness-aware distributed optimization circuitry 206 may be instantiated by the example microprocessor 1200 of FIG. 12 executing machine executable instructions such as those implemented by at least blocks 604 of FIG. 6 and/or blocks 802-812 of FIG. 8. In some examples, the staleness-aware distributed optimization circuitry 206 may be instantiated by hardware logic circuitry, which may be implemented by an ASIC, XPU, or the FPGA circuitry 1300 of FIG. 13 structured to perform operations corresponding to the machine readable instructions. Additionally or alternatively, the staleness-aware distributed optimization circuitry 206 may be instantiated by any other combination of hardware, software, and/or firmware. For example, the staleness-aware distributed optimization circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example deep learning accelerator circuitry 102 includes the example neural network circuitry 208. The neural network circuitry 208 implements a convolutional neural network (e.g., a deep neural network) that includes various convolutional layers, max pooling layers, fixed embedding layers, global averaging layers, etc. In some examples, the example neural network circuitry 208 may include additional and/or alternative machine learning models to predict a class label for a given example input data. For example, the neural network circuitry 208 may interoperate with any other classification algorithm (e.g., logistic regression, naive bayes, k-nearest neighbors, decision tree, support vector machine) to provide improved classification results.

The example neural network circuitry 208 includes neural network training circuitry. In some examples, the neural network circuitry 208 may be initialized with random weights. The neural network circuitry 208 may then retrieve training data (e.g., labeled test data) and adjust the weights to produce results consistent with the labeled test data (e.g., minimizing a loss function). The weights of the neural network circuitry 208 are adjusted based on gradient descent. However, the neural network circuitry 208 may be adjusted based on any other suitable optimization algorithm.

The example neural network circuitry 208 may retrieve training data from the example data storage 212 and use the retrieved data to train the example neural network circuitry 208. In some examples, the neural network circuitry 208 may perform pre-processing on the training data. In some examples, the neural network circuitry 208 may deduplicate elements of the training set before training.

In some examples, the deep learning accelerator circuitry 102 includes means for implementing a neural network. For example, the means for implementing a neural network may be implemented by the neural network circuitry 208. In some examples, the neural network circuitry 208 may be instantiated by processor circuitry such as the example processor circuitry 1112 of FIG. 11. For instance, the neural network circuitry 208 may be instantiated by the example microprocessor 1200 of FIG. 12 executing machine executable instructions such as those implemented by at least blocks 602 and 608 of FIG. 6. In some examples, the neural network circuitry 208 may be instantiated by hardware logic circuitry, which may be implemented by an ASIC, XPU, or the FPGA circuitry 1300 of FIG. 13 structured to perform operations corresponding to the machine readable instructions. Additionally or alternatively, the neural network circuitry 208 may be instantiated by any other combination of hardware, software, and/or firmware. For example, the neural network circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example deep learning accelerator circuitry 102 includes example communication circuitry 210. The example communication circuitry 210 transmits and/or receives information associated with the example deep learning accelerator circuitry 102. For example, a plurality of workstations (e.g., the first workstation 108, the second workstation 110, the third workstation 112, and the fourth workstation 114 of FIG. 1), each including instances of the communication circuitry 210, may communicate with a server to transmit/receive training data, classification results, a trained model (e.g., the neural network 104), etc. In some examples, the example communication circuitry 210 may transmit a model to a cloud server (e.g., a cloud server including an instance of the deep learning accelerator circuitry 102).

The example communication circuitry 210 additionally may coordinate communication between the operation classification circuitry 202, the inter-iteration scheduling circuitry 204, the example staleness-aware distributed optimization circuitry 206, the neural network circuitry 208, the training circuitry 210, and the data storage 212. Such communication may occur through a communication bus 214, for example.

In some examples, the deep learning accelerator circuitry 102 includes means for facilitating communication. For example, the means for facilitating communication may be implemented by the example communication circuitry 210. In some examples, the example communication circuitry 210 may be instantiated by processor circuitry such as the example processor circuitry 1112 of FIG. 11. For instance, the example communication circuitry 210 may be instantiated by the example microprocessor 1200 of FIG. 12 executing machine executable instructions such as those implemented by at least blocks 602-608 of FIG. 6. In some examples, the communication circuitry 210 may be instantiated by hardware logic circuitry, which may be implemented by an ASIC, XPU, or the FPGA circuitry 1300 of FIG. 13 structured to perform operations corresponding to the machine readable instructions. Additionally or alternatively, the example communication circuitry 210 may be instantiated by any other combination of hardware, software, and/or firmware. For example, the example communication circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example deep learning accelerator circuitry 102 includes the example data storage 212. The example data storage 212 stores training data for training the example neural network circuitry 208. The example data storage 212 can also store results of classifications performed by the example neural network circuitry 208, classifications generated by the operation classification circuitry 202, schedules generated by the inter-iteration scheduling circuitry 204, information related to stale gradients, etc.

In some examples, the deep learning accelerator circuitry 102 includes means for storing data generated by the deep learning accelerator circuitry 102. For example, the means storing data may be implemented by the example data storage 212. In some examples, the example data storage 212 may be instantiated by processor circuitry such as the example processor circuitry 1112 of FIG. 11. For instance, the example data storage 212 may be instantiated by the example microprocessor 1200 of FIG. 12 executing machine executable instructions such as those implemented by at least blocks 602-608 of FIG. 6. In some examples, the example data storage 212 may be instantiated by hardware logic circuitry, which may be implemented by an ASIC, XPU, or the FPGA circuitry 1300 of FIG. 13 structured to perform operations corresponding to the machine readable instructions. Additionally or alternatively, the example data storage 212 may be instantiated by any other combination of hardware, software, and/or firmware. For example, the example data storage 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the deep learning accelerator circuitry 102 of FIG. 1 is illustrated in FIG. 2, one or more of the elements, processes, and/or devices illustrated in FIG. 2 may be combined, divided, re-arranged, omitted, eliminated, and/or implemented in any other way. Further, the example operation classification circuitry 202, the example inter-iteration scheduling circuitry 204, the example staleness-aware distributed optimization circuitry 206, the example neural network circuitry 208, the example communication circuitry 210, the example data storage 212, and/or, more generally, the example deep learning accelerator circuitry 102 of FIG. 1, may be implemented by hardware alone or by hardware in combination with software and/or firmware. Thus, for example, any of the example operation classification circuitry 202, the example inter-iteration scheduling circuitry 204, the example staleness-aware distributed optimization circuitry 206, the example neural network circuitry 208, the example communication circuitry 210, the example data storage 212, and/or, more generally, the example deep learning accelerator circuitry 102 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example deep learning accelerator circuitry 102 of FIG. 1 may include one or more elements, processes, and/or devices in addition to, or instead of, those illustrated in FIG. 2, and/or may include more than one of any or all of the illustrated elements, processes and devices.

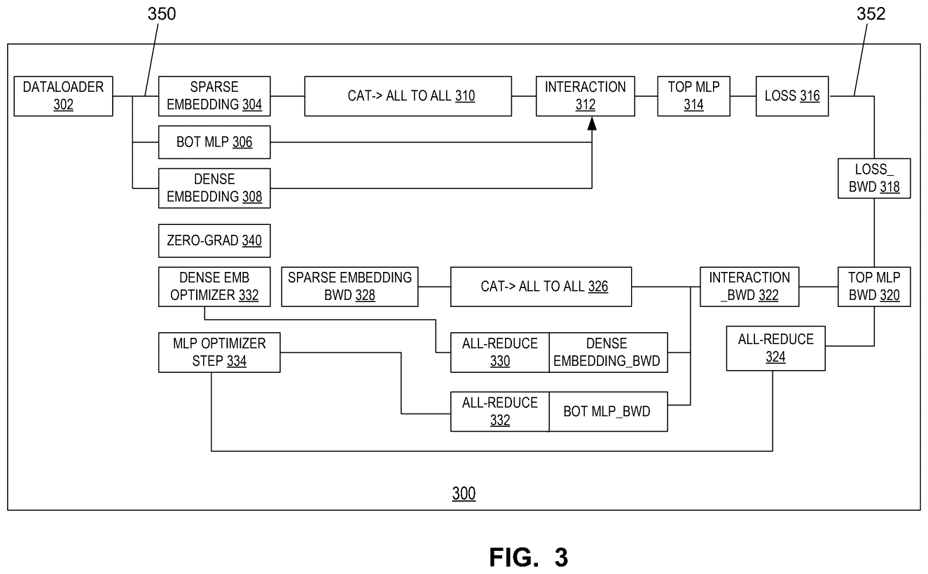

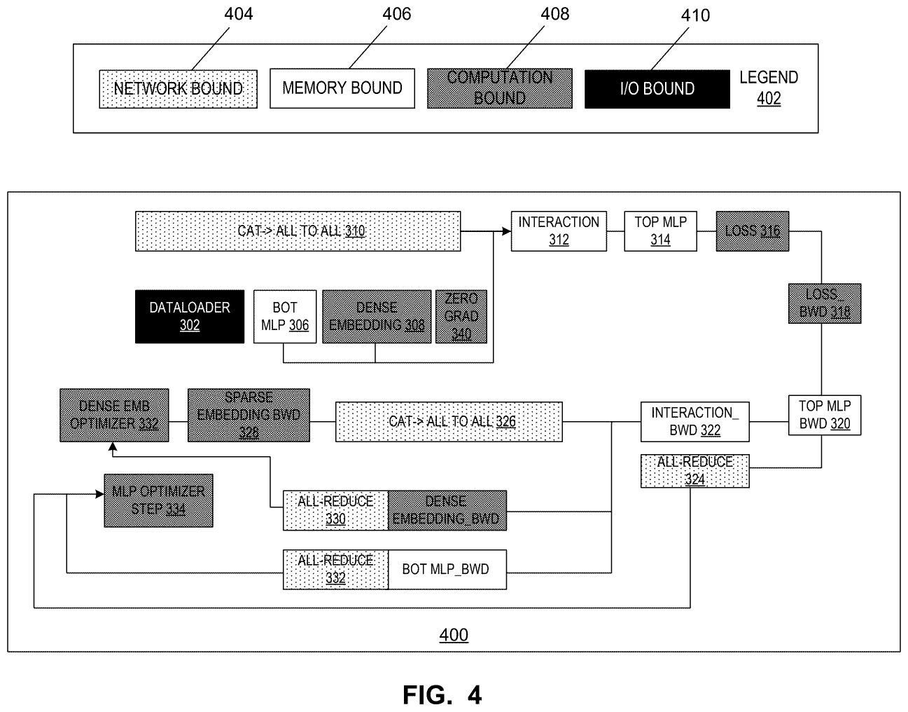

FIG. 3 is an example execution schedule 300 (e.g., an execution graph, a computation graph, etc.) for training of a deep learning workload. Specifically, the execution schedule is of an example deep learning recommendation model (DLRM). The DLRM input includes both dense (e.g., represented as floating point values) and sparse (e.g., represented as indices of embedding tables) input. FIGS. 4-6 illustrate how the deep learning accelerator circuitry 102 of FIG. 2 may optimize the execution schedule 300. However, FIGS. 3-6 illustrate only one example of the deep learning accelerator circuitry classifying operations and generating an execution schedule and the deep learning accelerator circuitry 102 can optimize any type of deep learning workload.

The example execution schedule 300 is represented as a directed acyclic graph (DAG). Each node in the graph (e.g., dataloader operation 302) represents an operation. Each edge in the graph (e.g., first edge 350) represents a data flow from one operation (e.g., a first operation) to another (e.g., a second operation). The execution schedule 300 is an execution schedule for one training iteration. Therefore, the example execution schedule 300 only illustrates an intra-iteration optimization (e.g., forward pass, backward pass, and weight updates) for training mode execution.

The execution schedule 300 begins at the dataloader operation 302. The dataloader operation 302 is a data loading operation that can iterate over a dataset. The dataloader operation 302 (e.g., load training data) is a parent node for a sparse embedding operation 304 (e.g., operation on sparse tensor), a bot mlp operation 306 (e.g., operation on multi-layer perceptron), and a dense embedding operation 308 (e.g., operation on dense tensor). Therefore, the first edge 350 connects the dataloader operation 302, the sparse embedding operation 304, the bot mlp operation 306, and the dense embedding operation 308. A cat all-to-all operation 310 (e.g., concatenate operation) is dependent on the sparse embedding operation 304. Accordingly, the interaction operation 312 is dependent on: a cat all-to-all operation 310 (e.g., concatenate), the bot mlp operation 306, and the dense embedding operation 308. The remaining operations 314-332 exhibit dependencies according to the same principals.

FIG. 4 is the example execution schedule of FIG. 3 after operations are classified by the example operation classification circuitry 202 of FIG. 2. The operation classification circuitry 202 classifies operations into one of four categories: network-bound, memory-bound, computation-bound, and I/O-bound. The four categories of classification are illustrated in the legend 402. The first legend entry 404 illustrates a first pattern (e.g., dotted pattern) to identify network-bound operations. The second legend entry 406 illustrates a second pattern (e.g., white background) to identify memory-bound operations. The third legend entry 408 illustrates a third pattern (e.g., grey background) to identify computation-bound operations. The fourth legend entry 410 illustrates a fourth pattern (e.g., black background) to identify I/O-bound operations. The example operation classification circuitry 202 identifies the operations of the execution schedule 300 of FIG. 3 to generate the classified execution schedule 400 of FIG. 4.

Each operation of the execution schedule 400 has been categorized into one of the four categories presented in the legend 402. For example, the dataloader operation 302 is I/O-bound. The first cat all-to-all operation 310, the second cat all-to-all operation 326, the first all-reduce operation 324, the second all-reduce operation 330, and the third all-reduce operation 332 are network-bound. The bot mlp operation 306, the interaction operation 312, the top mlp operation 314, a top mlp_bwd operation 320, an interaction bwd operation 322, and a bot mlp_bwd operation are classified as memory-bound. The inter-iteration scheduling circuitry 204 and the staleness-aware distributed optimization circuitry 206 can generate a schedule based on the classified execution schedule 400.

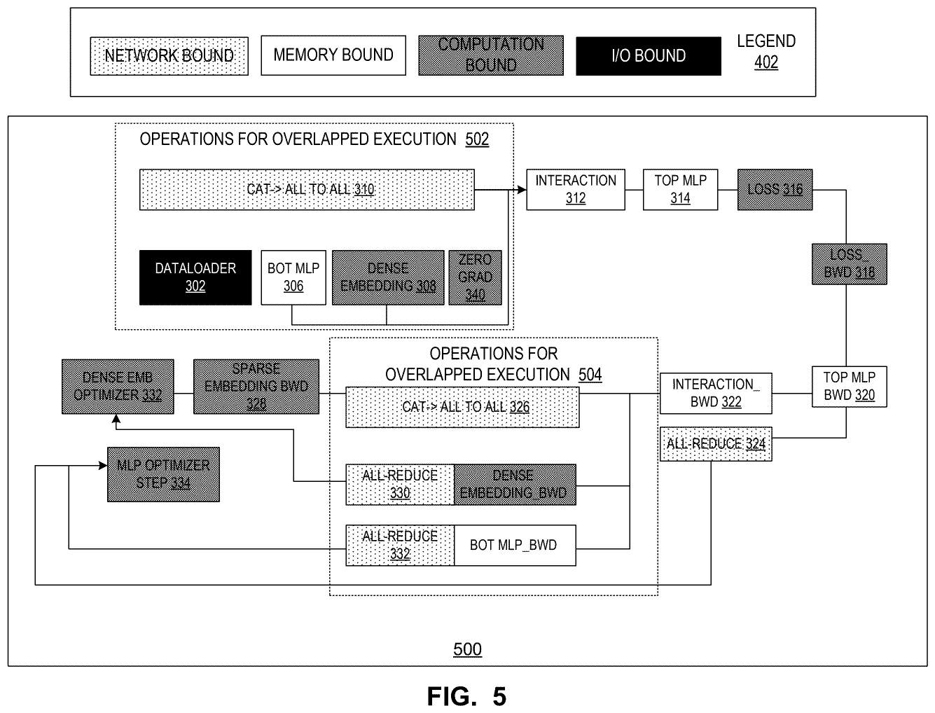

FIG. 5 is the example execution schedule of FIG. 4 after identification of segments of a third execution schedule 500 for overlapped execution by the inter-iteration scheduling circuitry 204 and/or the staleness-aware distributed optimization circuitry 206. The example third execution schedule 500 includes first operations for overlapped execution 502 and second operations for overlapped execution 504. The first operations for overlapped execution 502 is a group of operations that is identified by the inter-iteration scheduling circuitry 204 as being available for overlapped execution. For example, the cat all-to-all operation 310 is a network-bound operation, and therefore one or more of the bot mlp operation 306, the dense embedding operation 308, and/or the zero grad operation 340 can at least partially overlap execution of the cat all-to-all operation 310.

A flowchart representative of example machine readable instructions, which may be executed to configure processor circuitry to implement the deep learning accelerator circuitry 102 of FIG. 2, is shown in FIGS. 6-10. The machine readable instructions may be one or more executable programs or portion(s) of an executable program for execution by processor circuitry, such as the processor circuitry 1112 shown in the example processor platform 1100 discussed below in connection with FIG. 11 and/or the example processor circuitry discussed below in connection with FIGS. 12 and/or 13. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 6-10, many other methods of implementing the example deep learning accelerator circuitry 102 of FIG. 2 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-10 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 6 is a flowchart representative of example machine readable instructions and/or example operations 600 that may be executed and/or instantiated by processor circuitry to accelerate deep learning. The machine readable instructions and/or the operations 600 of FIG. 6 begin at block 602, at which the operation classification circuitry 202 of FIG. 2 classifies operations of a distributed deep-learning workload. The example operations 602 will be described in greater detail in association with FIG. 7. The instructions continue at block 604, at which the inter-iteration scheduling circuitry 204 of FIG. 2 identifies overlapping operations in the distributed deep learning workload. The operations 604 will be described in greater detail in association with FIG. 8.

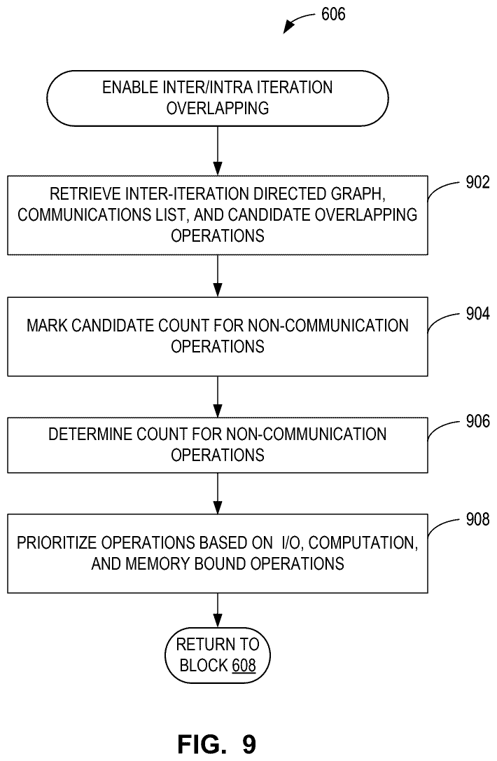

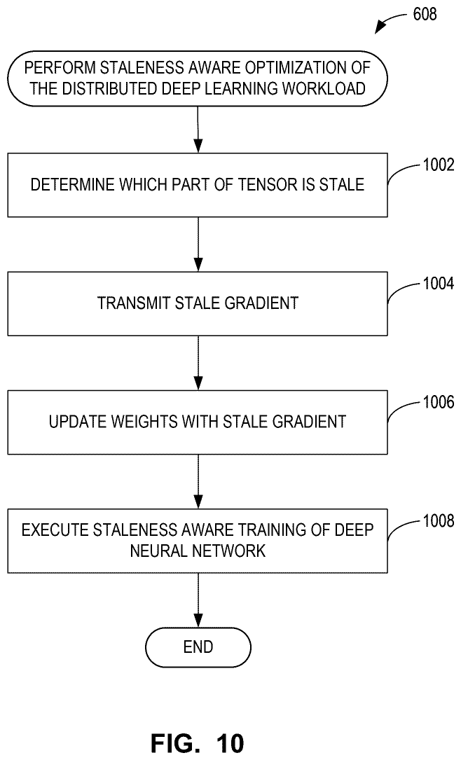

At block 606, the example inter-iteration scheduling circuitry 206 of FIG. 2 enables inter/intra-iteration execution of selected overlapping operations. The operations of block 606 will be described in greater detail in association with FIG. 9. At block 608, the example staleness-aware distributed optimization circuitry 206 of FIG. 2 executes a staleness-aware training of the neural network. The operations of block 608 will be described in greater detail in association with FIG. 10. The instructions end.

FIG. 7 is a flowchart representative of example machine readable instructions and/or example operations 602 that may be executed and/or instantiated by processor circuitry to classify operations of distributed deep learning workload. The machine readable instructions and/or the operations 602 of FIG. 7 begin at block 702, at which the example operation classification circuitry 202 of FIG. 2 determines if an operation is a communication operation. At block 704, if the example operation classification circuitry 202 of FIG. 2 determines the operation is a communication operation, control moves to block 706 at which the operation is classified as network-bound. If, at block 704, if the example operation classification circuitry 202 of FIG. 2 determines an operation is not a communication operation, control moves to block 708 at which the example operation classification circuitry 202 of FIG. 2 compares compute time to memory transfer time.

At block 710, if the example operation classification circuitry 202 of FIG. 2 determines CPU/GPU compute time is greater than memory transfer time, control moves to block 712 at which the operation classification circuitry 202 of FIG. 2 classifies the computation as computation-bound. If, at block 710, the example operation classification circuitry 202 of FIG. 2 determines an operation does not have a CPU/GPU compute time greater than a memory transfer time, control moves to block 714.

At block 714, the operation classification circuitry 202 of FIG. 2 compares memory transfer time to input/output transfer time. At block 716, if the example operation classification circuitry 202 of FIG. 2 determines a memory transfer time is greater than an I/O transfer time, control moves to block 718 at which the operation classification circuitry 202 of FIG. 2 classifies the operation as memory-bound. If, at block 716, if the example operation classification circuitry 202 of FIG. 2 determines an operation does not have a memory transfer time greater than an I/O transfer time, control moves to block 720 to classify the operation as I/O-bound. The instructions return to block 604.

FIG. 8 is a flowchart representative of example machine readable instructions and/or example operations 604 that may be executed and/or instantiated by processor circuitry to identify overlapping operations in an execution schedule. The machine readable instructions and/or the operations 604 of FIG. 8 begin at block 802, at which the example inter-iteration scheduling circuitry 204 of FIG. 2 retrieves an inter-iteration directed graph. Although the graph described in association with FIGS. 3-5 is a DAG with nodes representing operations and edges representing dependencies between operations, the information represented by the graph may be stored in any suitable format (e.g., a table, a sparse matrix, etc.) that includes data associating operations with dependencies between the operations.

At block 804, the example inter-iteration scheduling circuitry 204 of FIG. 2 profiles a workload associated with the graph for an execution time. In some examples, the workload profile may be precomputed and loaded (e.g., compute characteristics for operations are already known) rather than determined in real-time. At block 806, the example inter-iteration scheduling circuitry 204 of FIG. 2 identifies communication operations that are not a last allreduce in the execution graph.

At block 808, the example inter-iteration scheduling circuitry 204 of FIG. 2 identifies parent and output nodes for each identified communication operation. At block 810, the example inter-iteration scheduling circuitry 204 of FIG. 2 generates a candidate list with identified communication operations. For example, a candidate list of communication operations may be compiled to identify the communication operations for overlapped execution. Finally, at block 812, the example inter-iteration scheduling circuitry 204 of FIG. 2 associates entries in the candidate list with nodes in the inter-iteration directed graph that are between parent and child of candidate operation. The instructions return to block 606.

FIG. 9 is a flowchart representative of example machine readable instructions and/or example operations 606 that may be executed and/or instantiated by processor circuitry to enable inter/intra iteration overlapping.

The machine readable instructions and/or the operations 606 of FIG. 9 begin at block 902, at which the example inter-iteration scheduling circuitry 204 of FIG. 2 retrieves an inter-iteration directed graph, a communications list, and candidate overlapping operations. At block 904, the example inter-iteration scheduling circuitry 204 of FIG. 2 marks a candidate count for non-communication operations. Then, at block 906, the example inter-iteration scheduling circuitry 204 of FIG. 2 determines a count for non-communication operations. The operations of blocks 904 and 906 (e.g., and more generally the operations 606) correspond to the algorithm in Table 2 above. For example, a candidate count for a non-communication operation may be associated with a priority (e.g., higher count associated with greater priority). At block 908, the example inter-iteration scheduling circuitry 204 of FIG. 2 further prioritizes operations according to a priority of: I/O-bound, computation-bound, and memory-bound operations. For example, if there is more than one non-communication operation that can be overlapped with a communication operation, the priority of the non-communication operations may be determined by assigning I/O-bound operations as a highest priority, computation-bound operations as a second highest priority, and memory-bound operations as a third highest priority. The instructions return to block 608.

FIG. 10 is a flowchart representative of example machine readable instructions and/or example operations 608 that may be executed and/or instantiated by processor circuitry to perform a staleness aware optimization of the distributed deep learning workload.

The machine readable instructions and/or the operations 608 of FIG. 10 begin at block 1002, at which the example staleness-aware distributed optimization circuitry 206 of FIG. 2 identifies a stale portion of a tensor. For example, some computations may be executed with stale weights until the staleness-aware distributed optimization circuitry 206 of FIG. 2 makes use of the gradients. At block 1004, the example staleness-aware distributed optimization circuitry 206 of FIG. 2 transmits the stale gradients to another compute device in a staleness-aware communication. The staleness-aware distributed optimization circuitry 206 of FIG. 2 may update weights with stale gradients (e.g., identified based on the staleness-aware communication). At block 1006, the example staleness-aware distributed optimization circuitry 206 of FIG. 2 updates weights of the relevant neural network with the stale gradient. At block 1008, the example staleness-aware distributed optimization circuitry 206 of FIG. 2 executes a staleness aware training of the neural network. In some examples, a learning rate may be adjusted based on identification of a quantity of stale communications. The instructions end.

FIG. 11 is a block diagram of an example processor platform 1100 structured to execute and/or instantiate the machine readable instructions and/or the operations of FIGS. 6-10 to implement the deep learning accelerator circuitry 102 of FIG. 2. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1100 of the illustrated example includes processor circuitry 1112. The processor circuitry 1112 of the illustrated example is hardware. For example, the processor circuitry 1112 can be implemented by one or more integrated circuits, logic circuits, FPGAs, microprocessors, CPUs, GPUs, DSPs, and/or microcontrollers from any desired family or manufacturer. The processor circuitry 1112 may be implemented by one or more semiconductor based (e.g., silicon based) devices. In this example, the processor circuitry 1112 implements the example operation classification circuitry 202, the example inter-iteration scheduling circuitry 204, the example staleness-aware distributed optimization circuitry 206, the example neural network circuitry 208, the example communication circuitry 210, and the example data storage 212.

The processor circuitry 1112 of the illustrated example includes a local memory 1113 (e.g., a cache, registers, etc.). The processor circuitry 1112 of the illustrated example is in communication with a main memory including a volatile memory 1114 and a non-volatile memory 1116 by a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1116 may be implemented by flash memory and/or any other desired type of memory device. Access to the main memory 1114, 1116 of the illustrated example is controlled by a memory controller 1117.

The processor platform 1100 of the illustrated example also includes interface circuitry 1120. The interface circuitry 1120 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1122 are connected to the interface circuitry 1120. The input device(s) 1122 permit(s) a user to enter data and/or commands into the processor circuitry 1112. The input device(s) 1122 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1124 are also connected to the interface circuitry 1120 of the illustrated example. The output device(s) 1124 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1120 of the illustrated example, thus, typically includes a graphics driver card, a graphics driver chip, and/or graphics processor circuitry such as a GPU.

The interface circuitry 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1126. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1100 of the illustrated example also includes one or more mass storage devices 1128 to store software and/or data. Examples of such mass storage devices 1128 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1132, which may be implemented by the machine readable instructions of FIGS. 6-10, may be stored in the mass storage device 1128, in the volatile memory 1114, in the non-volatile memory 1116, and/or on a removable non-transitory computer readable storage medium such as a CD or DVD.

FIG. 12 is a block diagram of an example implementation of the processor circuitry 1112 of FIG. 11. In this example, the processor circuitry 1112 of FIG. 11 is implemented by a microprocessor 1200. For example, the microprocessor 1200 may be a general purpose microprocessor (e.g., general purpose microprocessor circuitry). The microprocessor 1200 executes some or all of the machine readable instructions of the flowcharts of FIGS. 6-10 to effectively instantiate the deep learning accelerator circuitry 102 as logic circuits to perform the operations corresponding to those machine readable instructions. In some such examples, the deep learning accelerator circuitry 102 is instantiated by the hardware circuits of the microprocessor 1200 in combination with the instructions. For example, the microprocessor 1200 may be implemented by multi-core hardware circuitry such as a CPU, a DSP, a GPU, an XPU, etc. Although it may include any number of example cores 1202 (e.g., 1 core), the microprocessor 1200 of this example is a multi-core semiconductor device including N cores. The cores 1202 of the microprocessor 1200 may operate independently or may cooperate to execute machine readable instructions. For example, machine code corresponding to a firmware program, an embedded software program, or a software program may be executed by one of the cores 1202 or may be executed by multiple ones of the cores 1202 at the same or different times. In some examples, the machine code corresponding to the firmware program, the embedded software program, or the software program is split into threads and executed in parallel by two or more of the cores 1202. The software program may correspond to a portion or all of the machine readable instructions and/or operations represented by the flowcharts of FIGS. 6-11.

The cores 1202 may communicate by a first example bus 1204. In some examples, the first bus 1204 may be implemented by a communication bus to effectuate communication associated with one(s) of the cores 1202. For example, the first bus 1204 may be implemented by at least one of an Inter-Integrated Circuit (I2C) bus, a Serial Peripheral Interface (SPI) bus, a PCI bus, or a PCIe bus. Additionally or alternatively, the first bus 1204 may be implemented by any other type of computing or electrical bus. The cores 1202 may obtain data, instructions, and/or signals from one or more external devices by example interface circuitry 1206. The cores 1202 may output data, instructions, and/or signals to the one or more external devices by the interface circuitry 1206. Although the cores 1202 of this example include example local memory 1220 (e.g., Level 1 (L1) cache that may be split into an L1 data cache and an L1 instruction cache), the microprocessor 1200 also includes example shared memory 1210 that may be shared by the cores (e.g., Level 2 (L2 cache)) for high-speed access to data and/or instructions. Data and/or instructions may be transferred (e.g., shared) by writing to and/or reading from the shared memory 1210. The local memory 1220 of each of the cores 1202 and the shared memory 1210 may be part of a hierarchy of storage devices including multiple levels of cache memory and the main memory (e.g., the main memory 1114, 1116 of FIG. 11). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1202 may be referred to as a CPU, DSP, GPU, etc., or any other type of hardware circuitry. Each core 1202 includes control unit circuitry 1214, arithmetic and logic (AL) circuitry (sometimes referred to as an ALU) 1216, a plurality of registers 1218, the local memory 1220, and a second example bus 1222. Other structures may be present. For example, each core 1202 may include vector unit circuitry, single instruction multiple data (SIMD) unit circuitry, load/store unit (LSU) circuitry, branch/jump unit circuitry, floating-point unit (FPU) circuitry, etc. The control unit circuitry 1214 includes semiconductor-based circuits structured to control (e.g., coordinate) data movement within the corresponding core 1202. The AL circuitry 1216 includes semiconductor-based circuits structured to perform one or more mathematic and/or logic operations on the data within the corresponding core 1202. The AL circuitry 1216 of some examples performs integer based operations. In other examples, the AL circuitry 1216 also performs floating point operations. In yet other examples, the AL circuitry 1216 may include first AL circuitry that performs integer based operations and second AL circuitry that performs floating point operations. In some examples, the AL circuitry 1216 may be referred to as an Arithmetic Logic Unit (ALU). The registers 1218 are semiconductor-based structures to store data and/or instructions such as results of one or more of the operations performed by the AL circuitry 1216 of the corresponding core 1202. For example, the registers 1218 may include vector register(s), SIMD register(s), general purpose register(s), flag register(s), segment register(s), machine specific register(s), instruction pointer register(s), control register(s), debug register(s), memory management register(s), machine check register(s), etc. The registers 1218 may be arranged in a bank as shown in FIG. 11. Alternatively, the registers 1218 may be organized in any other arrangement, format, or structure including distributed throughout the core 1202 to shorten access time. The second bus 1222 may be implemented by at least one of an I2C bus, a SPI bus, a PCI bus, or a PCIe bus

Each core 1202 and/or, more generally, the microprocessor 1200 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1200 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 13 is a block diagram of another example implementation of the processor circuitry 1112 of FIG. 11. In this example, the processor circuitry 1112 is implemented by FPGA circuitry 1300. For example, the FPGA circuitry 1300 may be implemented by an FPGA. The FPGA circuitry 1300 can be used, for example, to perform operations that could otherwise be performed by the example microprocessor 1200 of FIG. 12 executing corresponding machine readable instructions. However, once configured, the FPGA circuitry 1300 instantiates the machine readable instructions in hardware and, thus, can often execute the operations faster than they could be performed by a general purpose microprocessor executing the corresponding software.

More specifically, in contrast to the microprocessor 1200 of FIG. 12 described above (which is a general purpose device that may be programmed to execute some or all of the machine readable instructions represented by the flowcharts of FIGS. 6-10 but whose interconnections and logic circuitry are fixed once fabricated), the FPGA circuitry 1300 of the example of FIG. 13 includes interconnections and logic circuitry that may be configured and/or interconnected in different ways after fabrication to instantiate, for example, some or all of the machine readable instructions represented by the flowcharts of FIG. 13. In particular, the FPGA circuitry 1300 may be thought of as an array of logic gates, interconnections, and switches. The switches can be programmed to change how the logic gates are interconnected by the interconnections, effectively forming one or more dedicated logic circuits (unless and until the FPGA circuitry 1300 is reprogrammed). The configured logic circuits enable the logic gates to cooperate in different ways to perform different operations on data received by input circuitry. Those operations may correspond to some or all of the software represented by the flowcharts of FIGS. 6-10. As such, the FPGA circuitry 1300 may be structured to effectively instantiate some or all of the machine readable instructions of the flowcharts of FIGS. 6-10 as dedicated logic circuits to perform the operations corresponding to those software instructions in a dedicated manner analogous to an ASIC. Therefore, the FPGA circuitry 1300 may perform the operations corresponding to the some or all of the machine readable instructions of FIGS. 6-10 faster than the general purpose microprocessor can execute the same.

In the example of FIG. 13, the FPGA circuitry 1300 is structured to be programmed (and/or reprogrammed one or more times) by an end user by a hardware description language (HDL) such as Verilog. The FPGA circuitry 1300 of FIG. 13, includes example input/output (I/O) circuitry 1302 to obtain and/or output data to/from example configuration circuitry 1304 and/or external hardware 1306. For example, the configuration circuitry 1304 may be implemented by interface circuitry that may obtain machine readable instructions to configure the FPGA circuitry 1300, or portion(s) thereof. In some such examples, the configuration circuitry 1304 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1306 may be implemented by external hardware circuitry. For example, the external hardware 1306 may be implemented by the microprocessor 1200 of FIG. 12. The FPGA circuitry 1300 also includes an array of example logic gate circuitry 1308, a plurality of example configurable interconnections 1310, and example storage circuitry 1312. The logic gate circuitry 1308 and the configurable interconnections 1310 are configurable to instantiate one or more operations that may correspond to at least some of the machine readable instructions of FIGS. 6-10 and/or other desired operations. The logic gate circuitry 1308 shown in FIG. 13 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1308 to enable configuration of the electrical structures and/or the logic gates to form circuits to perform desired operations. The logic gate circuitry 1308 may include other electrical structures such as look-up tables (LUTs), registers (e.g., flip-flops or latches), multiplexers, etc.

The configurable interconnections 1310 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1308 to program desired logic circuits.

The storage circuitry 1312 of the illustrated example is structured to store result(s) of the one or more of the operations performed by corresponding logic gates. The storage circuitry 1312 may be implemented by registers or the like. In the illustrated example, the storage circuitry 1312 is distributed amongst the logic gate circuitry 1308 to facilitate access and increase execution speed.

The example FPGA circuitry 1300 of FIG. 13 also includes example Dedicated Operations Circuitry 1314. In this example, the Dedicated Operations Circuitry 1314 includes special purpose circuitry 1316 that may be invoked to implement commonly used functions to avoid the need to program those functions in the field. Examples of such special purpose circuitry 1316 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1300 may also include example general purpose programmable circuitry 1318 such as an example CPU 1320 and/or an example DSP 1322. Other general purpose programmable circuitry 1318 may additionally or alternatively be present such as a GPU, an XPU, etc., that can be programmed to perform other operations.

Although FIGS. 12 and 13 illustrate two example implementations of the processor circuitry 1112 of FIG. 11, many other approaches are contemplated. For example, as mentioned above, modern FPGA circuitry may include an on-board CPU, such as one or more of the example CPU 1320 of FIG. 13. Therefore, the processor circuitry 1112 of FIG. 11 may additionally be implemented by combining the example microprocessor 1200 of FIG. 12 and the example FPGA circuitry 1300 of FIG. 13. In some such hybrid examples, a first portion of the machine readable instructions represented by the flowcharts of FIGS. 6-10 may be executed by one or more of the cores 1202 of FIG. 12, a second portion of the machine readable instructions represented by the flowcharts of FIGS. 6-10 may be executed by the FPGA circuitry 1300 of FIG. 13, and/or a third portion of the machine readable instructions represented by the flowcharts of FIGS. 6-10 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 1112 of FIG. 11 may be in one or more packages. For example, the microprocessor 1200 of FIG. 12 and/or the FPGA circuitry 1300 of FIG. 13 may be in one or more packages. In some examples, an XPU may be implemented by the processor circuitry 1112 of FIG. 11, which may be in one or more packages. For example, the XPU may include a CPU in one package, a DSP in another package, a GPU in yet another package, and an FPGA in still yet another package.

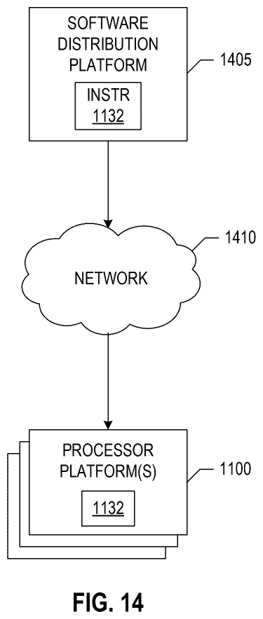

A block diagram illustrating an example software distribution platform 1405 to distribute software such as the example machine readable instructions 1132 of FIG. 11 to hardware devices owned and/or operated by third parties is illustrated in FIG. 14. The example software distribution platform 1405 may be implemented by any computer server, data facility, cloud service, etc., capable of storing and transmitting software to other computing devices. The third parties may be customers of the entity owning and/or operating the software distribution platform 1405. For example, the entity that owns and/or operates the software distribution platform 1405 may be a developer, a seller, and/or a licensor of software such as the example machine readable instructions 1132 of FIG. 11. The third parties may be consumers, users, retailers, OEMs, etc., who purchase and/or license the software for use and/or re-sale and/or sub-licensing. In the illustrated example, the software distribution platform 1405 includes one or more servers and one or more storage devices. The storage devices store the machine readable instructions 1132, which may correspond to the example machine readable instructions 600 of FIGS. 6-10, as described above. The one or more servers of the example software distribution platform 1405 are in communication with an example network 1410, which may correspond to any one or more of the Internet and/or the example network 116 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1132 from the software distribution platform 1105. For example, the software, which may correspond to the example machine readable instructions 600 of FIGS. 6-10, may be downloaded to the example processor platform 1100, which is to execute the machine readable instructions 1132 to implement the deep learning accelerator circuitry 102. In some examples, one or more servers of the software distribution platform 1405 periodically offer, transmit, and/or force updates to the software (e.g., the example machine readable instructions 1132 of FIG. 11) to ensure improvements, patches, updates, etc., are distributed and applied to the software at the end user devices.

From the foregoing, it will be appreciated that example systems, methods, apparatus, and articles of manufacture have been disclosed that accelerate deep learning. Disclosed systems, methods, apparatus, and articles of manufacture improve the efficiency of using a computing device by efficiently scheduling multi-chip DNN training based compute characteristics of the operations that comprise the DNN training. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to accelerate deep learning are disclosed herein. Further examples and combinations thereof include the following:

Example 1 includes a system comprising interface circuitry, programmable circuitry, and instructions to program the programmable circuitry to classify a group of operations of a distributed deep learning workload based on a resource utilization of the group of operations, select at least two operations of the group of operations for overlapped execution based on the classification and a dependency analysis of the at least two operations of the group of operations, and perform a distributed training of the distributed deep learning workload based on an execution schedule that includes overlapped execution of the selected at least two operations.

Example 2 includes the system of any of the previous examples, wherein the programmable circuitry is to classify the operations of the distributed deep learning workload into one of network-bound, computation-bound, memory-bound, or input/output-bound.

Example 3 includes the system of any of the previous examples, wherein the programmable circuitry is to perform an inter-iteration analysis of two operations of the group of operations with a directed graph, wherein an edge of the directed graph connects a forward operation with a backward operation with a same weight.

Example 4 includes the system of any of the previous examples, wherein the dependency analysis of the at least two operations of the group of operations indicates whether the at least two operations have different classifications and whether there is a data dependency between the at least two operations.

Example 5 includes the system of any of the previous examples, wherein the at least two operations are selected for overlapped execution in response to the at least two operations having different classifications and having no data dependency between the at least two operations.

Example 6 includes the system of any of the previous examples, wherein a first operation of the distributed deep learning workload is computation-bound, a second operation of the distributed deep learning workload is memory-bound, and wherein the system further includes a graphics processing unit to execute the computation-bound operation, and a data streaming accelerator to execute the memory-bound operation example 7 includes the system of example 1, wherein the programmable circuitry is to assign scheduling priorities to the at least two operations of the group of operations, and wherein input/output-bound operations are assigned a higher scheduling priority than computation-bound operations.

Example 8 includes the system of any of the previous examples, wherein the programmable circuitry is to identify a communication operation for overlapped execution in the at least two operations of the group of operations.

Example 9 includes the system of any of the previous examples, wherein in response to a quantity of communication operations being greater than a quantity of non-communication operations identified for overlapped execution, the programmable circuitry is to identify an operation of the communication operations for asynchronous execution.

Example 10 includes a computer readable medium comprising instructions which, when executed by processor circuitry, cause the processor circuitry to classify a group of operations of a distributed deep learning workload based on a resource utilization of the group of operations, select at least two operations of the group of operations for overlapped execution based on the classification and a dependency analysis of the at least two operations of the group of operations, and perform a distributed training of the distributed deep learning workload based on an execution schedule that includes overlapped execution of the selected at least two operations.

Example 11 includes the computer readable medium of any of the previous examples, wherein the instructions, when executed, cause the processor circuitry to classify the operations of the distributed deep learning workload into one of network-bound, computation-bound, memory-bound, or input/output-bound.

Example 12 includes the computer readable medium of any of the previous examples, wherein the instructions, when executed, cause the processor circuitry to perform an inter-iteration analysis of two operations of the group of operations with a directed graph, wherein an edge of the directed graph connects a forward operation with a backward operation with a same weight.

Example 13 includes the computer readable medium of any of the previous examples, wherein the dependency analysis of the at least two operations of the group of operations indicates whether the at least two operations have different classifications and whether there is data dependency between the at least two operations.

Example 14 includes the computer readable medium of any of the previous examples, wherein the at least two operations are selected for overlapped execution in response to the at least two operations having different classifications and having no data dependency between the at least two operations.

Example 15 includes the computer readable medium of any of the previous examples, wherein a first operation of the distributed deep learning workload is computation-bound, a second operation of the distributed deep learning workload is memory-bound, and wherein the system further includes a graphics processing unit to execute the computation-bound operation, and a data streaming accelerator to execute the memory-bound operation example 16 includes the non-transitory computer readable medium of example 10, wherein the instructions, when executed, cause the processor circuitry to assign scheduling priorities to the at least two operations of the group of operations, and wherein input/output-bound operations are assigned a higher scheduling priority than computation-bound operations.

Example 17 includes the computer readable medium of any of the previous examples, wherein the instructions, when executed, cause the processor circuitry to identify a communication operation for overlapped execution in the at least two operations of the group of operations.

Example 18 includes the computer readable medium of any of the previous examples, wherein in response to a quantity of communication operations being greater than a quantity of non-communication operations identified for overlapped execution, the instructions, when executed, cause the processor circuitry to identify an operation of the communication operations for asynchronous execution.

Example 19 includes a method comprising classifying, by executing an instruction with processor circuitry, a group of operations of a distributed deep learning workload based on a resource utilization of the group of operations, selecting, by executing an instruction with the processor circuitry, at least two operations of the group of operations for overlapped execution based on the classification and a dependency analysis of the at least two operations of the group of operations, and performing, by executing an instruction with the processor circuitry, a distributed training of the distributed deep learning workload based on an execution schedule that includes overlapped execution of the selected at least two operations.

Example 20 includes the method of any of the previous examples, further including classifying the operations of the distributed deep learning workload into one of network-bound, computation-bound, memory-bound, or input/output-bound.

Example 21 includes the method of any of the previous examples, further including performing an inter-iteration analysis of two operations of the group of operations with a directed graph, wherein an edge of the directed graph connects a forward operation with a backward operation with a same weight.

Example 22 includes the method of any of the previous examples, wherein the dependency analysis of the at least two operations of the group of operations indicates whether the at least two operations have different classifications and whether there is data dependency between the at least two operations.

Example 23 includes the method of any of the previous examples, wherein the at least two operations are selected for overlapped execution in response to the at least two operations having different classifications and having no data dependency between the at least two operations.

Example 24 includes the method of any of the previous examples, wherein a first operation of the distributed deep learning workload is computation-bound, a second operation of the distributed deep learning workload is memory-bound, and wherein the system further includes executing a computation-bound operation on a graphics processing unit, and executing a memory-bound operation on a data streaming accelerator unit.

Example 25 includes the method of any of the previous examples, further including assigning scheduling priorities to the at least two operations of the group of operations, and wherein input/output-bound operations are assigned a higher scheduling priority than computation-bound operations.

Example 26 includes the method of any of the previous examples, further including identifying a communication operation for overlapped execution in the at least two operations of the group of operations.

Example 27 includes the method of any of the previous examples, further including, in response to a quantity of communication operations being greater than a quantity of non-communication operations identified for overlapped execution, identifying an operation of the communication operations for asynchronous execution.

Example 28 includes a system comprising interface circuitry, programmable circuitry, and instructions to program the programmable circuitry to classify first and second operations of a distributed deep learning workload based on a first resource utilization of the first operation and a second resource utilization of the second operation, perform a dependency analysis on the first and second operations including identification of a parent node and an output node of the first and second operations, and generate an execution schedule for an inference that includes overlapped execution of the first and second operations.

1-28. (canceled)

29. A system comprising:
interface circuitry;
programmable circuitry; and
instructions to program the programmable circuitry to:
classify a group of operations of a distributed deep learning workload based on a resource utilization of the group of operations;
select at least two operations of the group of operations for overlapped execution based on the classification and a dependency analysis of the at least two operations of the group of operations; and
perform a distributed training of the distributed deep learning workload based on an execution schedule that includes overlapped execution of the selected at least two operations.

30. The system of claim 29, wherein the programmable circuitry is to classify the operations of the distributed deep learning workload into one of network bound, computation bound, memory bound, or input/output bound.

31. The system of claim 29, wherein the programmable circuitry is to perform an inter-iteration analysis of two operations of the group of operations with a directed graph, wherein an edge of the directed graph connects a forward operation with a backward operation with a same weight.

32. The system of claim 19, wherein the dependency analysis of the at least two operations of the group of operations indicates whether the at least two operations have different classifications and whether there is a data dependency between the at least two operations.

33. The system of claim 32, wherein the at least two operations are selected for overlapped execution in response to the at least two operations having different classifications and having no data dependency between the at least two operations.

34. The system of claim 19, wherein a first operation of the distributed deep learning workload is computation-bound, a second operation of the distributed deep learning workload is memory bound, and wherein the system further includes:
a graphics processing unit to execute the computation-bound operation; and
a data streaming accelerator to execute the memory bound operation.

35. The system of claim 19, wherein the programmable circuitry is to assign scheduling priorities to the at least two operations of the group of operations, and wherein input/output bound operations are assigned a higher scheduling priority than computation-bound operations.

36. The system of claim 19, wherein the programmable circuitry is to identify a communication operation for overlapped execution in the at least two operations of the group of operations.

37. The system of claim 36, wherein in response to a quantity of communication operations being greater than a quantity of non communication operations identified for overlapped execution, the programmable circuitry is to identify an operation of the communication operations for asynchronous execution.

38. A non-transitory computer readable medium comprising instructions which, when executed by processor circuitry, cause the processor circuitry to:
classify a group of operations of a distributed deep learning workload based on a resource utilization of the group of operations;
select at least two operations of the group of operations for overlapped execution based on the classification and a dependency analysis of the at least two operations of the group of operations; and
perform a distributed training of the distributed deep learning workload based on an execution schedule that includes overlapped execution of the selected at least two operations.

39. The non-transitory computer readable medium of claim 38, wherein the instructions, when executed, cause the processor circuitry to classify the operations of the distributed deep learning workload into one of network-bound, computation-bound, memory bound, or input/output bound.

40. The non-transitory computer readable medium of claim 38, wherein the instructions, when executed, cause the processor circuitry to perform an inter-iteration analysis of two operations of the group of operations with a directed graph, wherein an edge of the directed graph connects a forward operation with a backward operation with a same weight.

41. The non-transitory computer readable medium of claim 38, wherein the dependency analysis of the at least two operations of the group of operations indicates whether the at least two operations have different classifications and whether there is data dependency between the at least two operations.

42. The non-transitory computer readable medium of claim 41, wherein the at least two operations are selected for overlapped execution in response to the at least two operations having different classifications and having no data dependency between the at least two operations.

43. The non-transitory computer readable medium of claim 38, wherein a first operation of the distributed deep learning workload is computation-bound, a second operation of the distributed deep learning workload is memory bound, and wherein the instructions, when executed, cause the processor circuitry to:
execute the computation-bound operation; and
execute the memory bound operation.

44. The non-transitory computer readable medium of claim 38, wherein the instructions, when executed, cause the processor circuitry to assign scheduling priorities to the at least two operations of the group of operations, and wherein input/output bound operations are assigned a higher scheduling priority than computation-bound operations.

45. The non-transitory computer readable medium of claim 38, wherein the instructions, when executed, cause the processor circuitry to identify a communication operation for overlapped execution in the at least two operations of the group of operations.

46. The non-transitory computer readable medium of claim 45, wherein in response to a quantity of communication operations being greater than a quantity of non communication operations identified for overlapped execution, the instructions, when executed, cause the processor circuitry to identify an operation of the communication operations for asynchronous execution.

47. A method comprising:
classifying, by executing an instruction with processor circuitry, a group of operations of a distributed deep learning workload based on a resource utilization of the group of operations;
selecting, by executing an instruction with the processor circuitry, at least two operations of the group of operations for overlapped execution based on the classification and a dependency analysis of the at least two operations of the group of operations; and
performing, by executing an instruction with the processor circuitry, a distributed training of the distributed deep learning workload based on an execution schedule that includes overlapped execution of the selected at least two operations.

48. The method of claim 47, further including classifying the operations of the distributed deep learning workload into one of network bound, computation bound, memory bound, or input/output bound.
